(19) United States
(12) Patent Application Publication
(10) Pub. No.: US 2014/0101134 A1
(43) Pub. Date: Apr. 10, 2014

(54) SYSTEM AND METHOD FOR ITERATIVE ANALYSIS OF INFORMATION CONTENT

(71) Applicant: SOCIALFORCE, INC., Lake Forest Park, WA (US)

(72) Inventors: Richard A. Bohrer, Seattle, WA (US); William P. Urschel, Kirkland, WA (US); John C. Underwood, Mill Valley, CA (US); Thomas P. Maliska, JR., Olympia, WA (US)

(73) Assignee: SOCIALFORCE, INC., Lake Forest Park, WA (US)

(21) Appl. No.: 13/648,120

(22) Filed: Oct. 9, 2012

(51) Int. Cl. G06F 17/30

(52) U.S. Cl. 707/722; 707/736; 707/E17.014

(57) ABSTRACT

The present invention is directed to a system and method enabling the tracking of users, content and actions in respect to online content; assigning topics to online content; providing such information for analysis at a central systems; and providing an overview of users, content and actions in the aggregate. The processing of online interactions permits tracking users, identifying influential content and users, identifying the type of interactions that users prefer with respect to specific content, and so forth. As such, the system permits targeted and informed interactions with users and content sites, which recommendations are of value to, among others, online publishers, advertisers, search engines and users.

### FIELD OF THE INVENTION

The present disclosure relates to systems and methods for database creation, organization and management and, more particularly, to iterative collection, analysis and publication of dynamically updated information content.

### BACKGROUND OF THE INVENTION

With the advent and growth of social media, individuals and organizations have become interconnected more than ever in history. This in turn has led to an unprecedented level of influence exerted by such individuals and organizations on those within the ambit of their online activities, society or sphere of influence. A corresponding need has arisen to capture, document, evaluate and report in a meaningful way the degree of influence exercised by individuals and organizations based on interaction with information content.

Prior efforts to track and quantify usage of network content focused on the search and navigation aspect of online content. Of note in the search arena is the archival schema of image sites, which assign topics and keyword metadata to describe content, or for online content such as the image classification indexes used by Gettyimages.com. One might also reference the topic indexes in common use in library and periodical systems, or the topic schema applied to online content at Yahoo! Finally, there are search trees formed by relating content to questions, such as at AskJeeves.com, Ask.com, How.com, and Answer.com. Users framing knowledge in encyclopedic fashion is also exhibited at sites such as Wikipedia.com. In all of these approaches, it is common for there to be an independent review of the topic associated with online content in order that the searches on such content maintain some degree of relevance to the query.

Another approach to tracking content relevance is by navigation and use, for example, tracking user interactions (“hits”) on a page. In addition, a hybrid approach uses mathematical models for graph analysis to quantify references to online content, such as with the page ranking methodology adopted by Google (see, e.g., U.S. Pat. No. 6,285,999 as an example). Finally, the analysis of tracking cookies that store historical navigation data for a specific user or machine provides information about the type of content or online sites viewed or favored by that user, which in turn determines to some degree the relevance of the content and associated topics to one or more specific end users on a client machine. The art, to date, has not been able to determine with any accuracy or granularity the influence of a user in recommending content to others, by publication, forwarding references, authorship, and so forth of specific online content.

### BRIEF DESCRIPTION OF THE DRAWINGS

Preferred and alternative examples of the present invention are described in detail below with reference to the following drawings:

FIG. 1 is a diagram of an example embodiment showing the relationship overview for the present invention.

FIG. 2 is a diagram of an exemplary embodiment of the present invention showing the creation of a partial graph from a single user action.

FIG. 3 is a diagram of an exemplary embodiment of the present invention showing the sharing of a content source with a user.

FIG. 4 is a diagram of an exemplary embodiment of the present invention showing the consuming of a content source by a second user.

FIG. 5 is a diagram of an exemplary embodiment of the present invention showing the recording and tracking of events.

FIG. 6 is a diagram of an exemplary embodiment of the present invention showing the relationship between multiple shares and users.

FIG. 7 is a diagram of an exemplary embodiment of the present invention showing the assignment of content topics to content sources.

FIG. 8 is a diagram of an exemplary embodiment of the present invention showing the enumeration and recording of events.

FIG. 9 is a block diagram of an example computing system for an embodiment of the present invention

FIG. 10 is a block diagram of an example logical architecture for an embodiment of the present invention.

FIG. 11 is a block diagram of an example logical architecture of the graphical operation for an embodiment of the present invention.

FIG. 12 is a flow diagram of an example embodiment of the iterative collection methodology of the present invention.

FIG. 13 is a flow diagram of an example embodiment of the analysis methodology of the present invention.

FIG. 14 is a flow diagram of an example embodiment of the view/query/report methodology of the present invention.

FIG. 15 is a flow diagram of an example embodiment of an alternative iterative collection methodology of the present invention.

### DISCLOSURE DEFINITIONS

Catalog: merged collection of partial graphs.

Consume: viewing a content source shared by another user.

Content source: a social media post, website, blog, advertisement, product review or publication or other online source of data. This may be represented, without limitation, in the form of a Uniform Resource Identifier (URI) (including Uniform Resource Locator (URL) and Uniform Resource Name (URN)), network parameter, resource path name, Global Unique Identifier (GUID), alphanumeric identifier, defined search query, and the like.

Content topic: categorization assigned to one or more content sources bearing similar attributes. This may be represented, without limitation, in the form of a Uniform Resource Identifier (URI) (including Uniform Resource Locator (URL) and Uniform Resource Name (URN)), network parameter, resource path name, Global Unique Identifier (GUID), alphanumeric identifier, defined search query, and the like.

Event: Any user action.

Graph: a collection of vertices and edges that illustrate the relationship between users, content sources, topics, and the like. In the present invention, comprised of graph data related to a single event or action and/or group of related events or actions, or combinations of the same, for example of users, events, content source, content topics and relationships there between. Graphs may include partial graphs or subgraphs, catalogs and master graphs.

Influence: measurement associated with an identified user, a content source, a content topic or a referral source as a function of attributes such as ranking and polarity measurements.

Master Graph: a catalog reflecting analytic results.

Partial Graph or Subgraph: graph data related to a single event and/or group of related events, for example graph data describing users, actions, content source, content topics and relationships there between. A graph (whether partial graph or master graph) is a collection of vertices and edges that illustrate the relationship between users, content sources, topics and the like. The present invention preferably maintains information on each connection within the partial graphs as well as the master graph. This is because such connections have significance in the counting and scoring analysis of graphs. In enumerating graphs and analysis pursuant to the present invention, nodes are ranked or scored and edges are used to generate the analysis (e.g., to determine how many content connections a specific user has generated in a month). That said, it is possible to have graphs that are not connected to other parts of the graph, even related to different topics. In other words, it is not required that the graph be a “connected graph” where all nodes have some pathway or edge connected one to the other. Instead, the present invention contemplates, as well, the value of a “disconnected graph.”

Polarity: directional measurement associated with an identified user, a content source, a user action or a referral source.

Ranking: a measurement associated with an identified user, a content source, a content topic or a referral source based on a predetermined criteria.

Realm: A realm, or content topic, is a directed graph representing a taxonomy of the world, for example, into markets (e.g., digital cameras, women's fashion, commercial real estate) or a society (e.g., Republicans, Lutherans, environmentalists). Influencer attributes may be tied to a user and a realm (i.e., influence and total influence depend on the user and the realm under consideration). Realms are typically used to describe relationships between users and content.

Referral source: any source from which a relationship to content source originates such as a user, a content source or a location.

Share: publishing or otherwise disseminating a content source to another user, for example by sending an email link, posting on a blog or social media site, tweeting a picture, or other similar action.

User: any individual or organization whose actions are subject to tracking and association with the present invention.

User Action: any identifiable event instigated by an individual or organization such as viewing, consuming or sharing a content source. For example, responsive actions such as ‘like’ on Facebook, or share actions such as ‘tweet’ on Twitter, are user actions referencing content. This may be represented, without limitation, in the form of a Uniform Resource Identifier (URI) (including Uniform Resource Locator (URL) and Uniform Resource Name (URN)), network parameter, resource path name, Global Unique Identifier (GUID), alphanumeric identifier, defined search query, and the like.

View: accessing a content source in the first instance, not as shared by a referral source.

### DETAILED DESCRIPTION OF THE PREFERRED EMBODIMENT

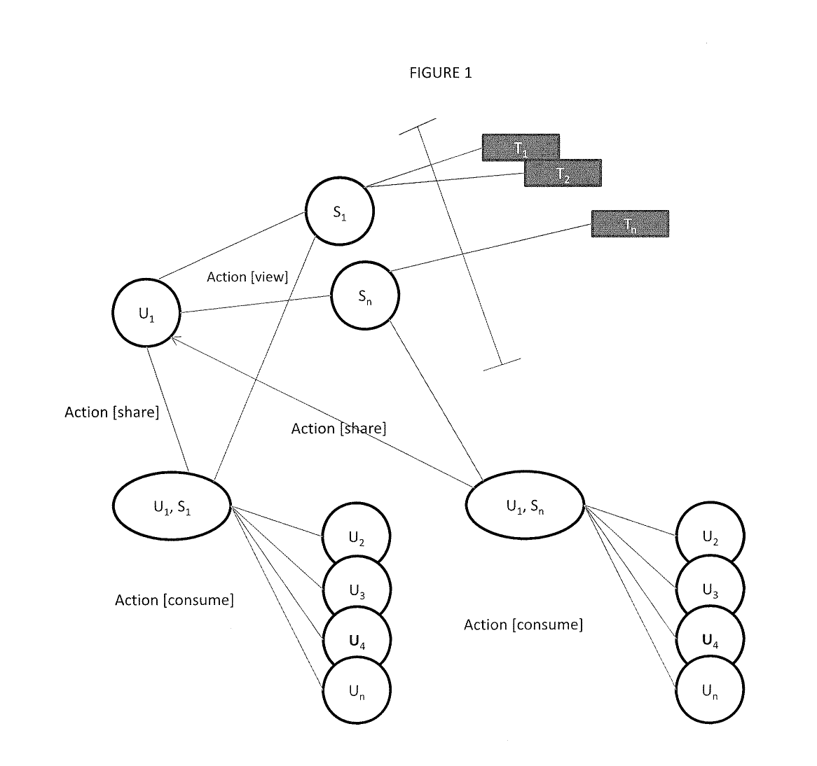

Embodiments described herein provide iterative collection, analysis and publication systems and methods for dynamically creating, organizing, managing and reporting information content gathered based on the ascribed influence of individuals, content sources and organizations. By way of overview of the claimed technology, reference is made to FIG. 1, which outlines the association between users, user actions, content sources and content topics. Users may be any individual or organization whose actions are subject to tracking and association with the present invention. User actions may be any identifiable event instigated by an individual or organization such as viewing, consuming or sharing a content source. A content source includes any online source of data that may be maintained in a database structure.

### Tracking User Actions Online

One essential tool for tracking the actions of an individual user browsing network content (such as on web pages), is a cookie. A cookie is a browser text file that allows the system to identify on the user and pages or topics visited, which is saved on the client computer for reference on future occasions. The visitor is preferably identified with a unique but nondescript identifier. Cookies are valuable because they can be used to target advertising, public relations, and direct marketing offers, anywhere that person shows up on the Internet. Programs, such as embedded code or scripts in a client website or a landing page, may enable the placement and tracking of cookies on visitors. This permits the tracking of content and referrals by the present invention, using the cookie mechanism to generate partial graphs.

Online publishers often associate cookies with their visitors, and collect profiles of their users online for purposes such as customizing content for personal viewing. They may also share cookie information with their partners; partners may include, for example, bloggers (and blogging platforms), podcasters (and podcast platforms), shopping sites (especially those that publish reviews), online advertising networks and exchanges, and news sites (wirefeeds, magazines, press releases). Other sources are client chatrooms, blogs, social pages (e.g., Facebook, MySpace, LinkedIn), and inbound emails.

Other types of user interactions may result in stored information about the user or their browsing and content viewing habits. For example, a system may process various data, such as point-of-sale, telemarketing and telephone survey calls, resulting in collection of data such as identification name, user name, phone number and email address. This class of data may not initially be tied to a cookie, in which case it may later be matched and merged with another record that has a cookie. As noted, cookies may be shared or accessed by multiple online network sources (for example, content partners who do a newspaper and a blog about the daily news). Bloggers (and blogging platforms), podcasters (and podcast platforms), shopping sites (especially those that publish reviews), online advertising networks and exchanges, and news sites (wirefeeds, magazines, press releases) are examples of such content partners

Content topics are categorizations assigned to one or more content sources bearing similar attributes, shared information permits content customization across partners and, as such, the activities of users is invaluable in order to determine which users consume, and which refer information to others. However, given the wide variety of content sites and approaches to this problem, including without limitation ad forwarders, listening posts, Internet crawlers, advertising referral sites, content vendors, there is no uniform way to track content usage and referrals, and customize interactions with users on their client machines. The following describes embodiments of the present invention offering a uniform and universal approach for achieving this end.

With reference to FIG. 1, U₁ is a first user identifiable within the present system, for example, an individual or organization. U₁ may perform an action with respect to a first content source S₁, such as a website, by viewing the website. This view action may be recorded by the system as a partial data graph. The first content source S₁ may fall within a content topic, for example, T₁ or T₂ U₁ may subsequently view additional content sources Sₙ, which in turn may fall within one or more content topics.

U₁ may also share the first content source S₁, creating shared content U₁,S₁, which indicates that U₁ has shared the first content S₁. U₁ may thereafter perform an action with respect to one or more additional users U₂ through Uₙ namely, sharing information about the first content source S₁, for example by sending an email link, posting on a blog, or other similar action, thereby becoming a referral source. The actions of additional users U₂ through Uₙ consuming the shared first content S₁ from U₁ may be recorded by the system as a collection of partial data graphs in a catalog. In similar fashion, U₁ may also share additional viewed content sources, such as Sₙ, indicating new shared content U₁,S₁. U₁ may thereafter perform an action with respect to one or more additional users U₂ through Uₙ namely, sharing information about content source Sₙ, for example by sending an email link, posting on a blog, or other similar action, thereby becoming a referral source. Again, the actions of additional users U₂ through Uₙ consuming the shared first content S₁ from Uₙ may be recorded by the system as a collection of partial data graphs in a catalog. Additional users, content sources and related topics may thus be interrelated in dynamic, growing relationships based on users, user actions, content sources and content topics.

As it is collected, this relationship information is analyzed in order to (1) assign a ranking; (2) assign a polarity; (3) assign an influence measurement; and (4) filter the resulting data for purposes of producing graphical outputs and reports.

### Graphical Data Collection

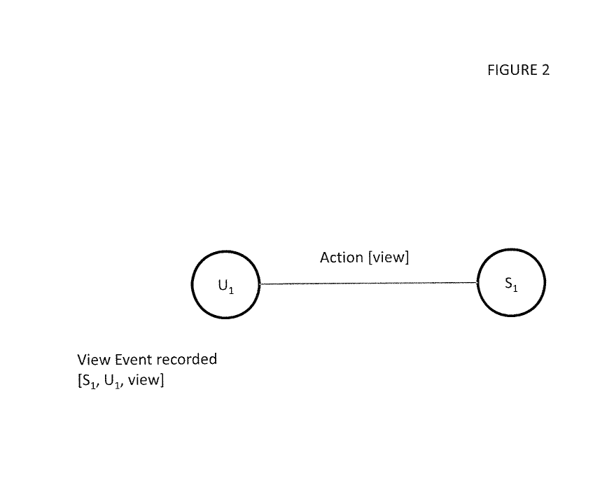

An exemplary embodiment describing the collection, analysis and graphical publication of information content in canonical form is set forth with reference to FIGS. 2-8. FIG. 2 illustrates the creation of a partial graph from a single user action, namely, user U₁ performing the action of viewing content source 51. The present invention preferably records this event using a tuple descriptor for the partial graph using three elements: content source 51 (e.g., a URI for S₁), user U₁ (e.g., a unique identifier assigned to U₁); and the action performed by U₁ (e.g., view content):
[S₁, U₁, view]

For purposes of illustration, we include the descriptors for the content source, user and action in the partial data graph as tuples in this application, without the intent of limiting the invention described thereby. Note that the use of the tuple format is for purposes of rendering the description in this specification more understandable, and that the actual format for partial data graph descriptors in a computing system will typically involve encoding techniques and optimizations that are not human-readable, and that may take a number of forms depending on the specific communication protocols and encoding methodologies required.

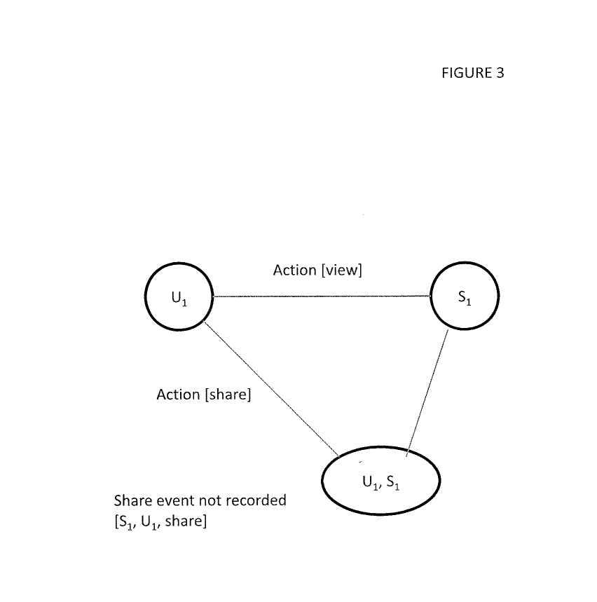

FIG. 3 illustrates the result when content source 51 is shared by user U1, namely, the creation of partial data graph describing node U1,S1. Although no independent partial graph is required to describe the share action, it may be desirable that the shared content source S1 is labeled with a URI indicating that it was shared by U1.

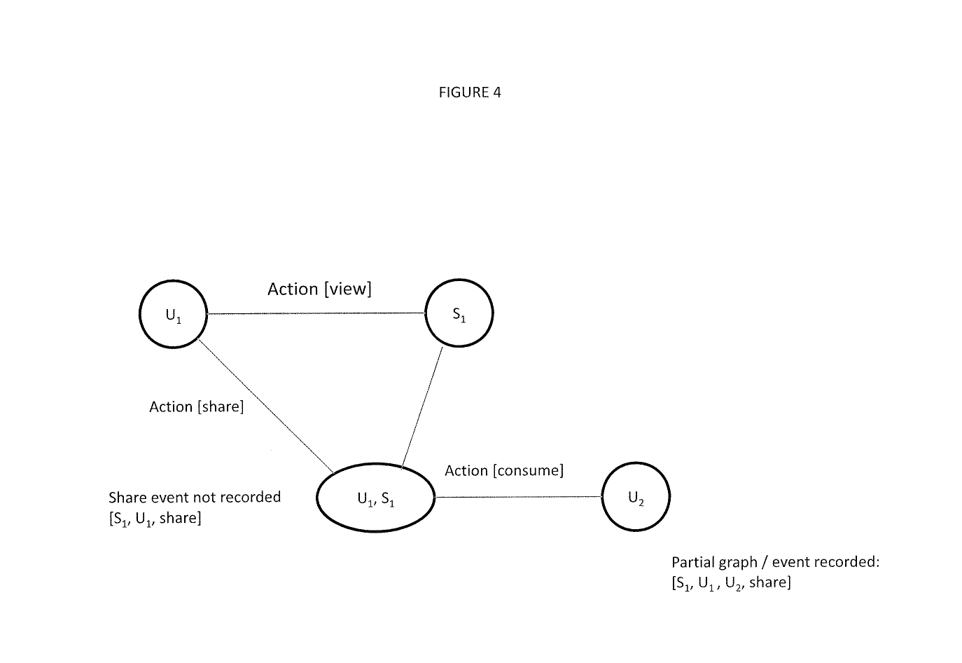

FIG. 4 illustrates a recordable event that occurs when a new user U2 consumes content S1 shared by U1, namely, consumption of shared content node U1,S1 by user U2. The present invention records this as a partial data graph tuple. When user U2 consumes S1 shared by U1 an event is created indicating that user U1 shared the shared content S1 with user U2, namely, the following tuple descriptor:
[S₁, U₁, U₂, share]
   Share events are derived or inferred from consume events using the tracking method to distinguish users related to the sharing and the viewing.

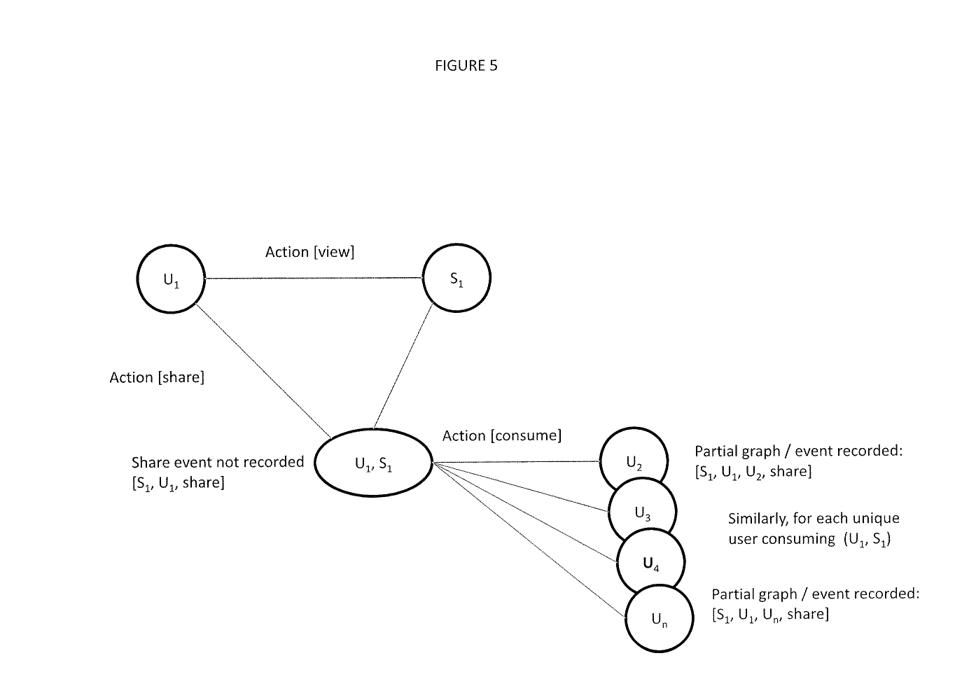

FIG. 5 illustrates the creation of partial graphs with each consumption of shared content U₁,S₁ by users U₃ through Uₙ. In this example, as explained above, an event is recorded for user U₃ consuming the shared content, S₁ by user U1 with the following partial graph descriptor: [S₁, U₁, U₃, share] Likewise, events are recorded using partial graph descriptors for each unique user U₃ through Uₙ consuming shared content U₁,S₁, as follows:
[S₁, U₁, Uₙ, share]

Reference to FIGS. 2-5 describe that in the preferred operation of the present invention, a view occurs by a user in the first instance. In contrast, the consumption of shared content is performed by another user. There is preferably a one to one correlation between events and users, each of which create partial graphs or subgraphs. A merged collection of partial graphs results in a master graph, which may be analyzed for and filtered according to desired criteria, for example, with respect to users, events, topics or other metadata.

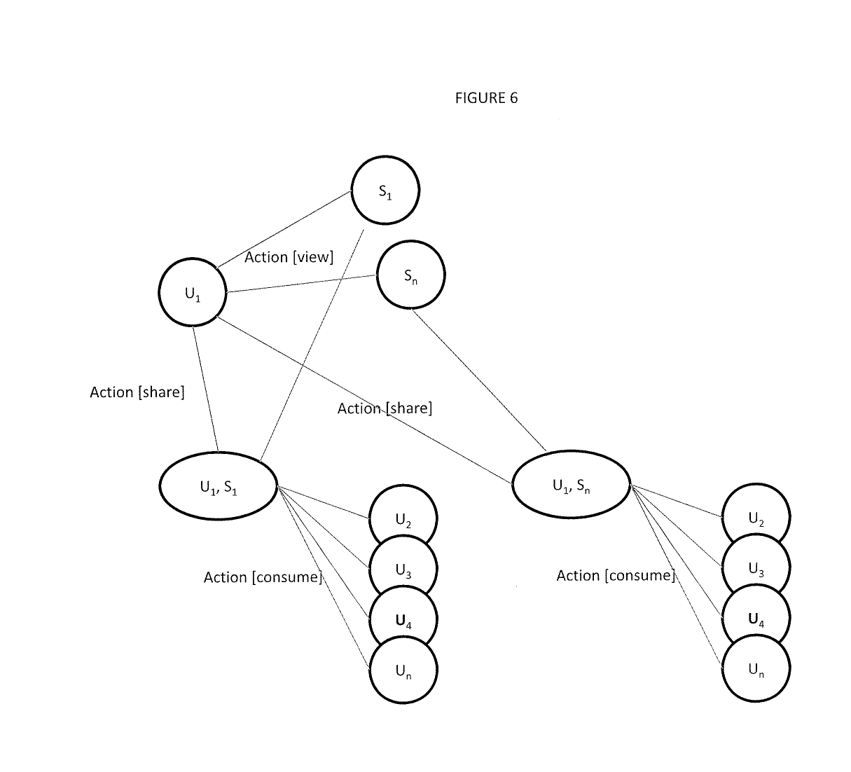

The above described system and method may be used in a progressive and iterative manner to efficiently track, record and eventually publish or display in graphical or other form the resulting master graph, for example displaying the sharing and consumption of content, or providing access to ranking and influence information. For example, FIG. 6 illustrates the natural progression of the above-described system and method in the creation of partial graphs tracking additional content sharing and consumption events. Specifically, for subsequent sharing by user U₁ of content sources 51 creates shared content U₁,S₁. Additional partial graphs are created with each consumption of node U₁,S₁ by users U₂ through Uₘ, which are recorded for each unique user U₂ through Uₙ, consuming node U₁,S₁, as follows:
[S₁, U₁, Uₘ, share]

Similarly, for subsequent sharing by user U1 of additional content sources Sn creates shared content U1,Sn. Additional partial graphs are created with each consumption of node U1,Sn by users U2 through Un, which are recorded for each unique user U2 through Un consuming node U1,S1, as follows:
[Sₙ, U₁, Uₙ, share]

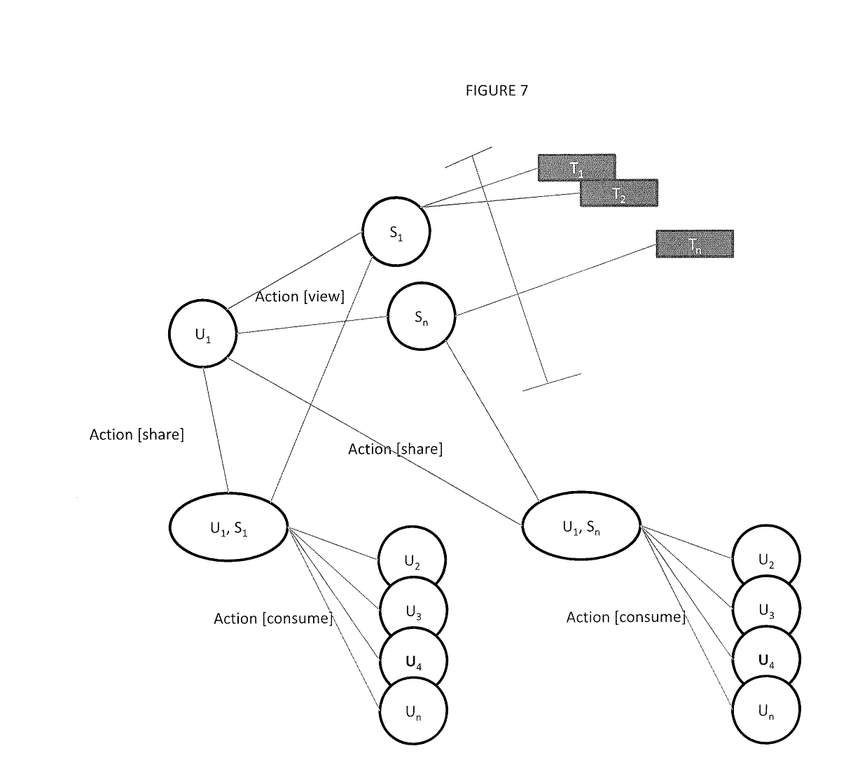

FIG. 7 illustrates how further relationship information is tracked, merged and associated with recorded events by reference to content topics. Content topics are the categorization assigned to one or more content sources bearing similar attributes. When partial graphs from the network are communicated as descriptors to the catalog system, merging into the master graph database is preferably done by an asynchronous process that associates one or more content topics with content sources. As shown in FIG. 7, for example, content source S₁ may be associated with topics T₁ and T₂. In a similar fashion, content source Sᵣ, may be associated with one or more topics. This association preferably occurs independent of event tracking and recording or the merger of partial graphs into a master catalog, as illustrated by the demarcation in FIG. 7 between the content sources and related actions and the topics.

Topics may be represented in the present invention in a variety of ways. For example, topics and their relationships may be maintained in a tree structure according to a predetermined criteria based on the relatedness of the topics to each other. Alternatively, topics may be maintained according to unique keys. Regardless of the encoding method, content topics are useful in providing descriptions of the relationship between users and content. In one embodiment, additional partial graphs are constructed by merging topics with existing partial graphs to create a relationship between a user and a content source. These partial graphs preferably carry metadata describing the relationship, such as describing the specific user action taken. Examples include “spammed, blocked, rated, ranked, deleted, subscribed, copied, printed, downloaded, blacklisted, whitelisted, sent as URI, tagged, and the like, or shared in association with crowd source and social media applications such as Twitter, DIGG, FaceBook, and the like.

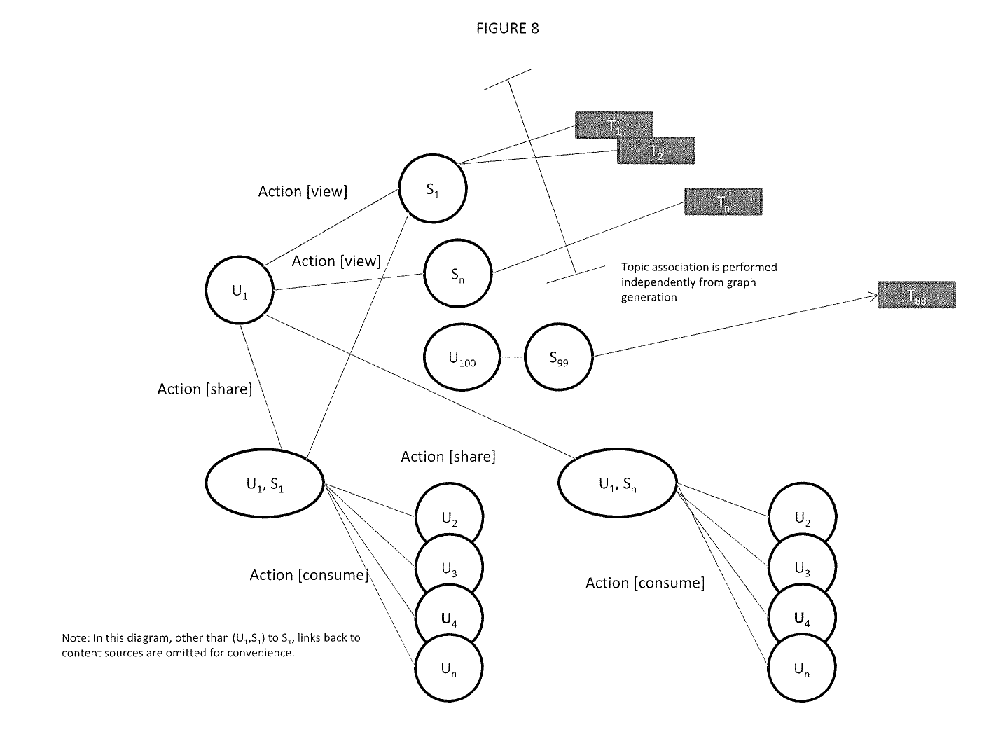

FIG. 8 illustrates how events are enumerated and stored within the present invention. As explained above, user U₁ generates N events by viewing content sources S₁ to Sₙ. Likewise, users U₂ to Uₙ generate N events by their independent consumption of shared content U₁,S₁. Preferably these various events are enumerated during the process of merging the partial graphs into the master graph. In a preferred embodiment, the present invention performs deduplication after merging partial graphs; in other words, it compares partial graphs for overlap and redundancies to reduce or eliminate anomalies, errors, and duplicate entries in the catalog. This provides more efficient algorithmic processing, such as scoring and ranking, and also reduces data storage requirements.

In a preferred embodiment, Internet communications standard protocols, such as HTTP, are used. A content source may be identified by a URL. The URL contains a descriptor of the user sharing the content. The browser cookie is used to identify the user viewing the content. Thus, using Internet communications standards under HTTP, the present invention may derive and forward to a catalog partial graph descriptors for an event.

### Analysis of Influence

After data is collected and stored, the present invention analyzes the information to generate influence measures associated with users content sources, content topics and any referral sources based on a variety of metrics derived from the recorded events and topic categorization. Such metrics may include, for example, views of a particular content by a specified number of users over a period of time; repeat use of content by one or more users; unique view of content by one or more users; content referrals (e.g. via blogging or e-mail) by one or more users, and the amount of interaction of others with those referrals.

Polarity or influence may be derived, as well as these other known measures, in the form of a directional measurement associated with the approval or disapproval expressed by content during a period of time, which content includes an identified user, a content source, a user action or a referral source; language analysis, review scores, or other ratings can be made and associated with the content and user in order to indicate if the Polarity is positive, negative or neutral. In addition, other well-known audience metrics may be associated with the unique interaction with content and user defined by Polarity, such as geographic metrics (e.g., country, city, state/region, zip code, area code, latitude and longitude, etc.) and demographic metrics (e.g., gender, age bracket, etc.). An IP address may be used to reasonably determine a variety of geographic and demographic characteristics. Weighted or statistical measures may also be applied.

Page rank algorithms may be used to rank the importance of web pages based on the number and quality of links between pages. The resulting influence is preferably a time-dependent value representing influence made at a specific point in time and meaningful for a defined period of time (e.g., postings remain available for 30 days) or ongoing level of user interaction (e.g. explicit reporting continues until user interaction with the content drops below 10 per day). For example, it is appropriate to value a user's influence, for example, today, last week, or last month. In addition, a total influence value may be determined as a singular time-independent value representing influence over all time.

In the present invention, events forming partial or master graphs have been created and cataloged, and influence ascertained by tracking activity over time and/or a number of interaction events, and reports generated. A subscriber to the graph database reporting system may obtain information from system graph stores, with access to rankings engines, that form part of the catalog system of the present invention. Basic subscriber operations include the ability to navigate and select a dataset based on a set of partial graphs; to query, analyze, create, delete, group, join, extract, reformat, display and generate reports. This is preferably accomplished via APIs, user interfaces/command lines, data exchanges, graphical displays or web browsers, or client/server applications.

### System Architecture

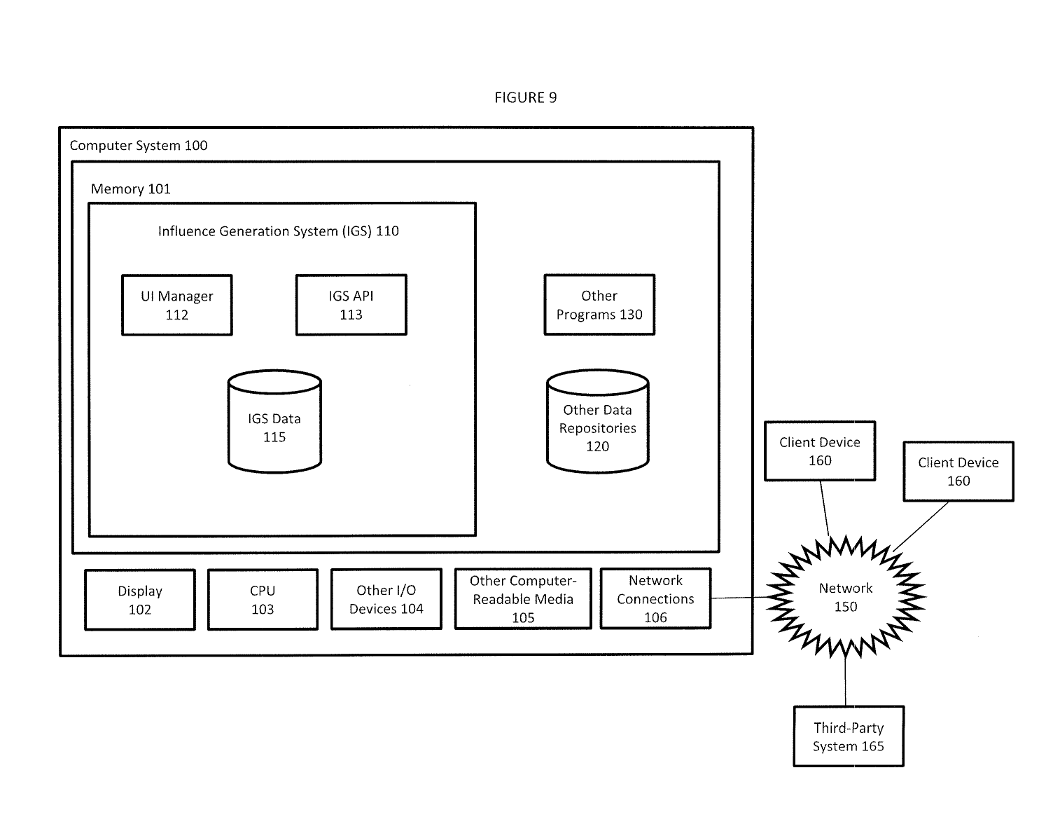

FIG. 9 is a block diagram of an example computing system for implementing an influence generation system (IGS) 110 according to an example embodiment. Note that one or more general purpose or special purpose computing systems/devices may be used to implement the IGS 110. In addition, the computing system 100 may comprise one or more distinct computing systems/devices and may span distributed locations. Furthermore, each block shown may represent one or more such blocks as appropriate to a specific embodiment or may be combined with other blocks. Also, the IGS 110 may be implemented in software, hardware, firmware, or in some combination to achieve the capabilities described herein.

In the embodiment shown, computing system 100 comprises a computer memory (“memory”) 101, a display 102, one or more Central Processing Units (“CPU”) 103, Input/Output devices 104 (e.g., keyboard, mouse, CRT or LCD display, and the like), other computer-readable media 105, and network connections 106 connected to a network 150. The IGS 110 is shown residing in memory 101. In other embodiments, some portion of the contents, some or all of the components of the IGS 110 may be stored on and/or transmitted over the other computer-readable media 105. The components of the IGS 110 preferably execute on one or more CPUs 103 and manage processes as described herein. Other code or programs 130 (e.g., an administrative interface, a Web server, and the like) and potentially other data repositories, such as data repository 120, also reside in the memory 101, and preferably execute on one or more CPUs 103. Of note, one or more of the components in FIG. 4 may not be present in any specific implementation. For example, some embodiments may not provide other computer readable media 105 or a display 102.

The IGS 110 includes a user interface (“UI”) manager 112, an IGS application program interface (“API”) 113, and an IGS data store 115.

The UI manager 112 provides a view and a controller that facilitate user interaction with the IGS 110 and its various components. For example, the UI manager 112 may provide interactive access to the IGS 110, such that administrators can manage and update the system and provide reports and users can track system functionality as it pertains to them or their system requests as well as receive reports, and the like. In some embodiments, access to the functionality of the UI manager 112 may be provided via a Web server, possibly executing as one of the other programs 130. In such embodiments, a user operating a Web browser (or other client) executing on one of the client devices 160 or 161 can interact with the IGS 110 via the UI manager 112.

The API 113 provides programmatic access to one or more functions of the influence generation system 110. For example, the API 113 may provide a programmatic interface to one or more functions of the IGS 110 that may be invoked by one of the other programs 130 or some other module. In this manner, the API 113 facilitates the development of third-party software, such as user interfaces, plug-ins, news feeds, adapters (e.g., for integrating functions of the IGS 110 into Web applications), and the like. In addition, the API 113 may be in at least some embodiments invoked or otherwise accessed via remote entities, such as the third-party system 165, to access various functions of the IGS 110. For example, a social networking service executing on the system 165 may obtain information about influence measures and reports from the IGS 110 via the API 113.

The data store 115 is used by the other modules of the IGS 110 to store and/or communicate information. The components of the IGS 110 use the data store 115 to securely store or record various types of information, including user identification, content source, user actions, referral source identification, correlation information, assigned rankings and polarity and influence measures, and the like. Although the components of the IGS 110 are described as communicating primarily through the data store 115, other communication mechanisms are contemplated, including message passing, function calls, pipes, sockets, shared memory, and the like.

The IGS 110 interacts via the network 150 with client devices 160 and third-party systems 165. The third-party systems 165 may include social networking systems, third-party authentication or identity services, identity information providers (e.g., credit bureaus), or the like. The network 150 may be any combination of one or more media (e.g., twisted pair, coaxial, fiber optic, radio frequency), hardware (e.g., routers, switches, repeaters, transceivers), and one or more protocols (e.g., TCP/IP, UDP, Ethernet, Wi-Fi, WiMAX) that facilitate communication between remotely situated humans and/or devices. In some embodiments, the network 150 may be or include multiple distinct communication channels or mechanisms (e.g., cable-based and wireless). The client devices 160 include personal computers, laptop computers, smart phones, personal digital assistants, tablet computers, and the like.

In an example embodiment, components/modules of the IGS 110 are implemented using standard programming techniques. For example, the IGS 110 may be implemented as a “native” executable running on the CPU 103, along with one or more static or dynamic libraries. In other embodiments, the IGS 110 may be implemented as instructions processed by a virtual machine that executes as one of the other programs 130. In general, a range of programming languages known in the art may be employed for implementing such example embodiments, including representative implementations of various programming language paradigms, including but not limited to, object-oriented (e.g., Java, C++, C#, Visual Basic.NET, Smalltalk, and the like), functional (e.g., ML, Lisp, Scheme, and the like), procedural (e.g., C, Pascal, Ada, Modula, and the like), scripting (e.g., Perl, Ruby, Python, JavaScript, VBScript, and the like), and declarative (e.g., SQL, Prolog, and the like).

The embodiments described below may also use either well-known or proprietary synchronous or asynchronous client-server computing techniques. Also, the various components may be implemented using more monolithic programming techniques, for example, as an executable running on a single CPU computer system, or alternatively decomposed using a variety of structuring techniques known in the art, including but not limited to, multiprogramming, multithreading, client-server, or peer-to-peer, running on one or more computer systems each having one or more CPUs. Some embodiments may execute concurrently and asynchronously, and communicate using message passing techniques. Equivalent synchronous embodiments are also supported. Partial graph descriptors may be communicated in batch, real-time, on an event clock, with rules (e.g., representing tasks such as “always merge topics, events from this user in batch mode hourly”), or the like. Also, other functions could be implemented and/or performed by each component/module, and in different orders, and by different components/modules, yet still achieve the described functions.

In addition, programming interfaces to the data stored as part of the IGS 110, such as in the data store 115, can be available by standard mechanisms such as through C, C++, C#, and Java APIs; libraries for accessing files, databases, or other data repositories; through scripting languages such as XML; or through Web servers, FTP servers, or other types of servers providing access to stored data. The data store 118 may be implemented as one or more database systems, file systems, or any other technique for storing such information, or any combination of the above, including implementations using distributed computing techniques.

Different configurations and locations of programs and data are contemplated for use with techniques of described herein. A variety of distributed computing techniques are appropriate for implementing the components of the illustrated embodiments in a distributed manner including but not limited to TCP/IP sockets, RPC, RMI, HTTP, Web Services (XML-RPC, JAX-RPC, SOAP, and the like). Other variations are possible. Also, other functionality could be provided by each component/module, or existing functionality could be distributed amongst the components/modules in different ways, yet still achieve the functions described herein.

Furthermore, in some embodiments, some or all of the components of the IGS 110 may be implemented or provided in other manners, such as at least partially in firmware and/or hardware, including, but not limited to one or more application-specific integrated circuits (“ASICs”), standard integrated circuits, controllers executing appropriate instructions, and including microcontrollers and/or embedded controllers, field-programmable gate arrays (“FPGAs”), complex programmable logic devices (“CPLDs”), and the like. Some or all of the system components and/or data structures may also be stored as contents (e.g., as executable or other machine-readable software instructions or structured data) on a computer-readable medium (e.g., as a hard disk; a memory; a computer network or cellular wireless network or other data transmission medium; or a portable media article to be read by an appropriate drive or via an appropriate connection, such as a DVD or flash memory device) so as to enable or configure the computer-readable medium and/or one or more associated computing systems or devices to execute or otherwise use or provide the contents to perform at least some of the described techniques. Some or all of the system components and data structures may also be stored as data signals (e.g., by being encoded as part of a carrier wave or included as part of an analog or digital propagated signal) on a variety of computer-readable transmission mediums, which are then transmitted, including across wireless-based and wired/cable-based mediums, and may take a variety of forms (e.g., as part of a single or multiplexed analog signal, or as multiple discrete digital packets or frames). Such computer program products may also take other forms in other embodiments. Accordingly, embodiments of this disclosure may be practiced with other computer system configurations.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “includes,” “including,” “comprises,” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

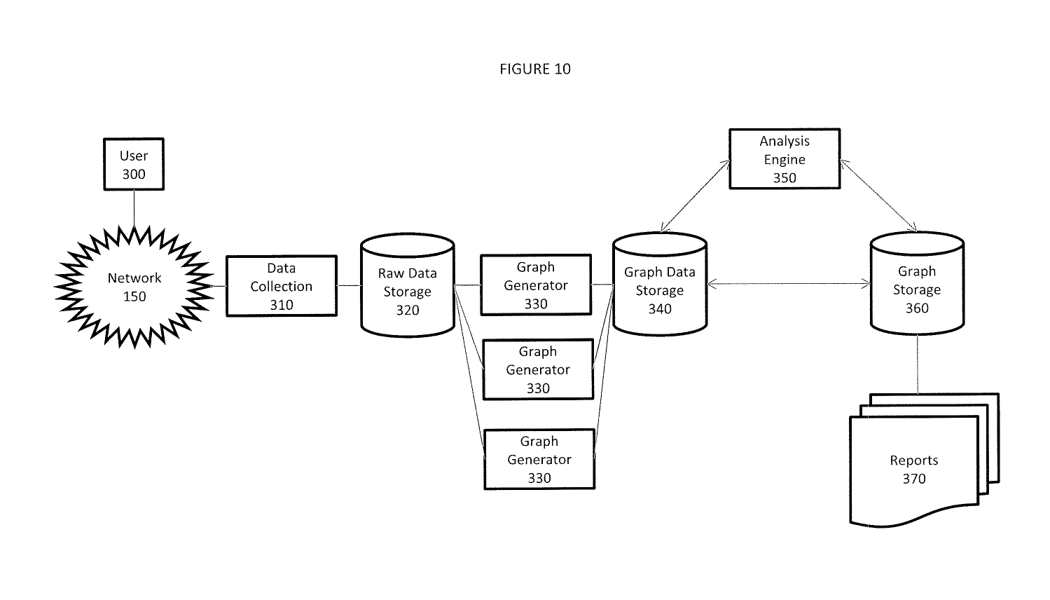

FIG. 10 shows an example of the logical architecture of an embodiment of the present invention. The architecture includes a system user 300 from which events are received via a network 150 at data collection 310, which in turn is stored in raw data storage 320. Optionally, one or more graph generators 330 are used to generate or modify existing partial graphs. The resulting partial graphs are passed. The resulting graphical data is stored in graph data storage 340. At predetermined intervals, or prompted by subscriber queries, an analysis engine 350 is used to ascertain rankings and ultimately influence information about users and their actions, which are both stored in graph storage 360 and published in reports 375. Graph data may be stored either in graph data storage 340 or graph storage 360.

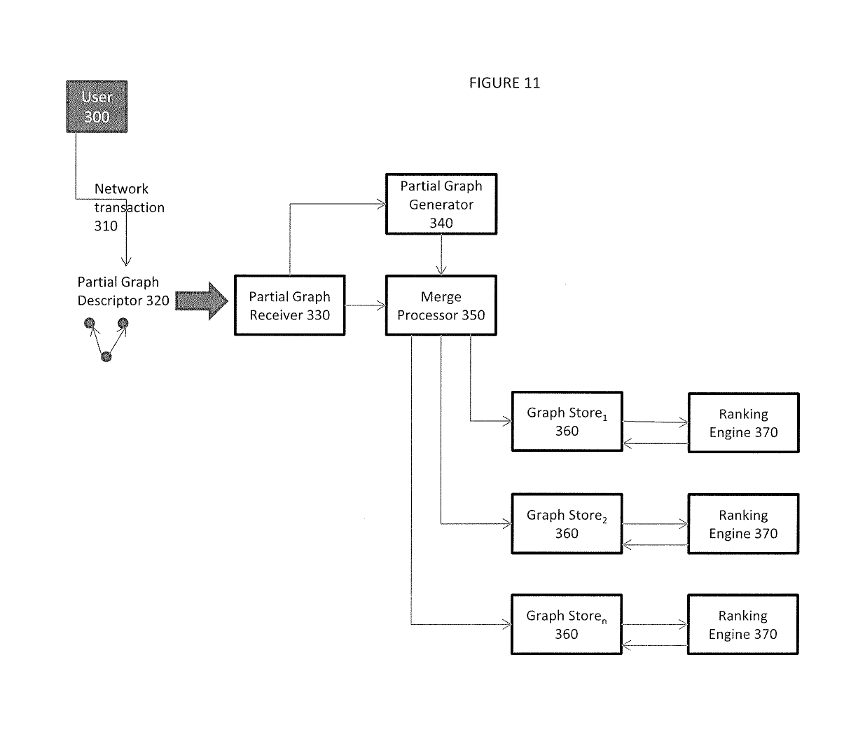

FIG. 11 shows an example logical architecture of the graphical operation, namely, the graphical storage and ranking generators, for the present invention. In one embodiment, a user 300 performs an action that is recorded as an event via a network transaction 310, which results in a partial graph descriptor 320. A partial graph receiver 330 sends the data to both a partial graph generator 340 and a merge processor 350. The partial graph descriptors received from the network are preferably stored as raw data format, and a graph is generated purposefully (e.g., to extract specific information for scoring or ranking). The partial graph generator 340 may be a web crawler automated to find and record transactions, may take in communications from network nodes or users containing partial graph descriptors, or the like. After merging both the raw data and that produced by the partial graph generator, the data is stored in graph stores 1 through n 360. Multiple graph stores may be generated from the merge operation depending on the analysis required (e.g., last seven days' transactions, most important content, selected users, etc.) The data storage system may be virtual, in memory or on hard disk. Preferably the data storage system will persist or store data for maintenance and operational integrity. A subscriber may obtain information from system graph stores, including rankings and ultimately influence information about users and their actions, from the graph stores 360 and associated rankings engines 370, which form part of the catalog system of the present invention. As noted above, this may occur at predetermined intervals, or prompted by subscriber queries

### System Processes

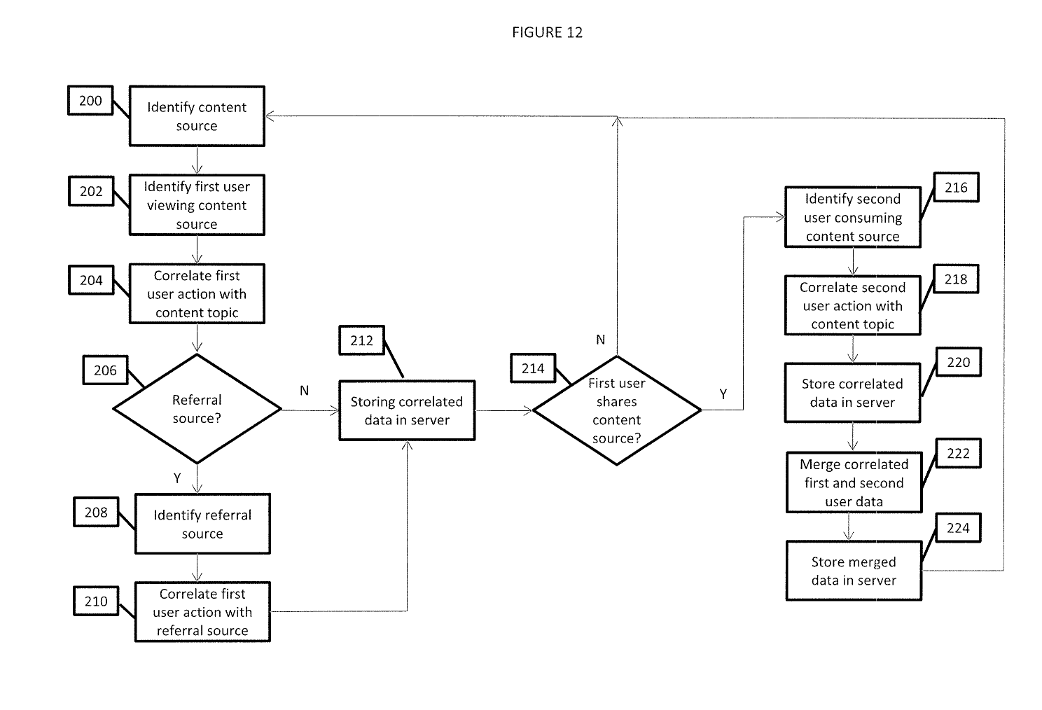

Embodiments of the methodology associated with the present invention are described with reference to FIGS. 12-15.

FIG. 12 illustrates an embodiment of the iterative collection methodology of the present invention. At block 200, the system identifies a content source, such as a social media post, website, blog, advertisement, product review or publication or other online source of data. This may be represented in a variety of forms, such as a URI, network parameter, resource path name, GUID, alphanumeric identifier, defined search query, and the like. At block 202 the system identifies a first user, for example an individual or organization, viewing the content source. At block 204, in the preferred embodiment, the system correlates the first user action with a content topic. This is optional, however, dependent on whether one or more content topics exist, as well as whether the particular application desires such correlation. At decision block 206, a determination is made whether the content source was referred by a referral source, such as a different user, a content source or a location. If so, the logic proceeds to block 208, where the system identifies the referral source, and block 210, where the first user's action is correlated with the referral source. The logic proceeds at that point to block 212, where the data collected and correlated pertaining to the first user action is stored in a server. This data is also referred to as partial graph information. If at decision block 206 a determination is made that the content source was not referred by a referral source, the logic proceeds directly to block 212.

At decision block 214, a determination is made whether the first user shares the content source. If not, the logic returns to block 200 to await a new event and repeat of the above-described methodology. If a determination is made that the first user shared the content source, the logic proceeds to block 216. At block 216, the system identifies a second user consuming the content source. In the preferred embodiment, the recordable event may be either the sharing of the content source or the consumption of the content source, or both. The logic proceeds to block 218, where in the preferred embodiment, the system correlates the second user action with a content topic. This is optional, however, dependent on whether one or more content topics exist, as well as whether the particular application desires such correlation. At block 220, the data collected and correlated pertaining to the second user action is stored in a server. This data is also referred to as partial graph information. At block 222, the stored data associated with the first and second user actions is merged with the catalog. The stored data, which reflects one or more partial graphs, form a catalog. The logic proceeds to block 224, where the merged data, or catalogs, are preferably stored in a catalog server. The logic then returns to block 200 to await a new event and repeat of the above-described methodology. It will be appreciated that this methodology may be repeated in iterative fashion with the same or additional content sources, content topics, users and referral sources.

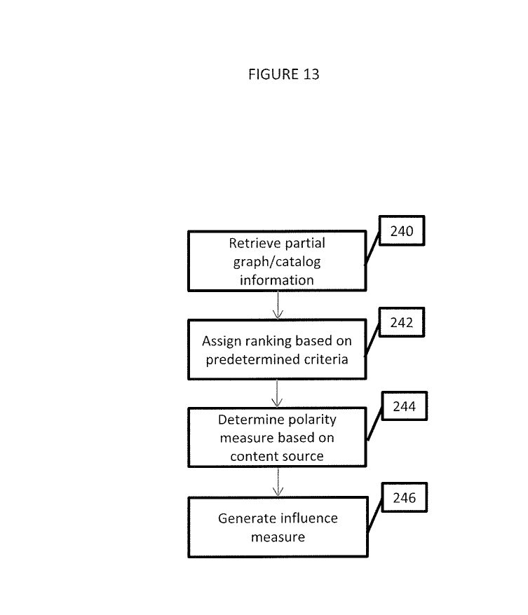

FIG. 13 illustrates an embodiment of the analysis methodology of the present invention. Assuming storage of and access to partial graphs or catalogs, at block 240 such data is retrieved. At block 242, the system assigns a ranking or measurement associated with an identified user, a content source, a content topic or a referral source based on a predetermined criteria. At block 244, the system determines a polarity or directional measurement associated with an identified user, a content source, a user action or a referral source. In the preferred embodiment, this is based on the associated content sources. At block 246, the system generates an influence score, or a measurement associated with an identified user, a content source, a content topic or a referral source as a function of attributes such as ranking and polarity measurements.

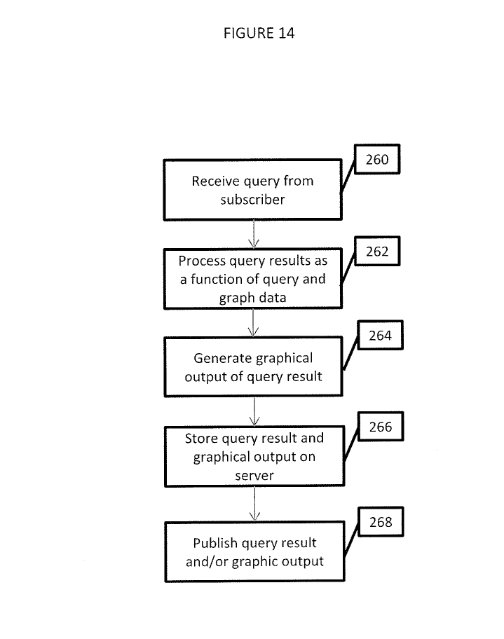

FIG. 14 illustrates an embodiment of the view/query/report methodology of the present invention. Assuming storage of and access to partial graphs or catalogs, as well as master graphs including analytics from analysis of previously collected data, at block 260 the system received a query from a subscriber seeking information about one or more of an identified user, a content source, a content topic or a referral source. At block 262, the system processes the query to produce results as a function of the query parameters and stored graphs data, which may include one or more partial graphs, catalogs or master graph information. At block 264, the system generates an output of the query result. While the report may take a variety of forms, it preferably includes a graphical output illustrating the influence and other measures in context to the relationships between events and data. At block 266, the query result and output is preferably stored on the system server, for example, the catalog server. At block 268, the system publishes the query result and the output to the subscriber.

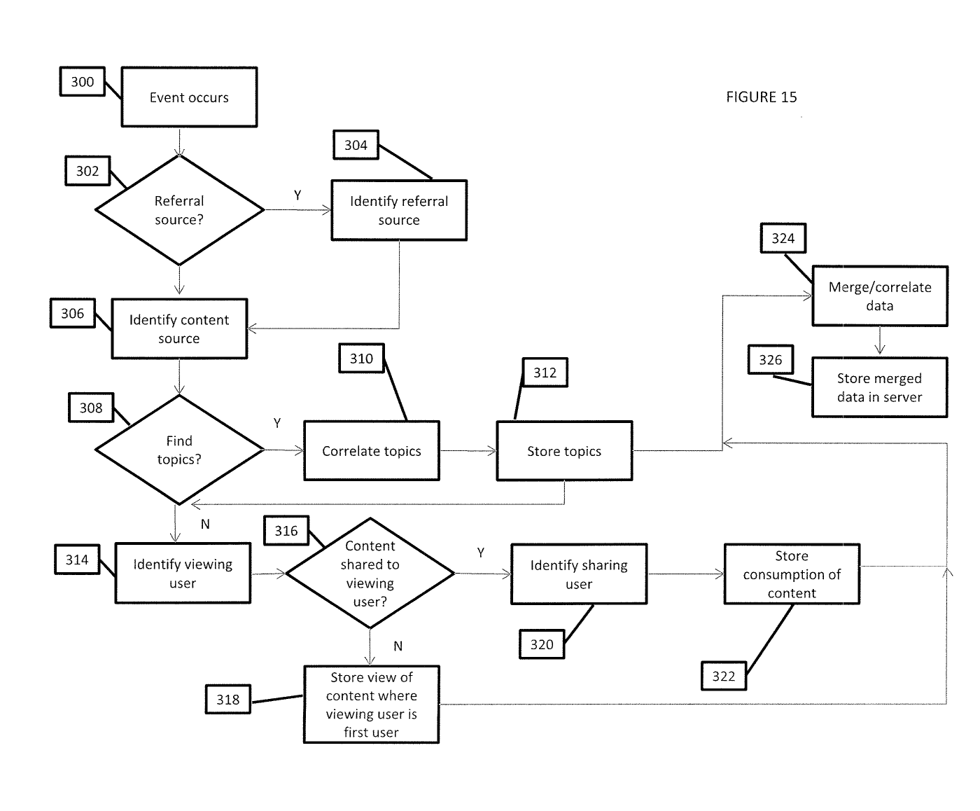

FIG. 15 illustrates an alternative embodiment of the iterative collection methodology of the present invention. This methodology may be combined with the analysis and view/query/report methodologies set forth above, including with reference to FIGS. 13 and 14. At block 300, an event occurs, which may be any user action or, in other words, anything instigated by an individual or organization such as viewing, consuming or sharing a content source. At decision block 302, a determination is made whether the event is associated with a referral source, such as a different user, a content source or a location. If so, the logic proceeds to block 304, where the system identifies the referral source, after which the logic proceeds to block 306. If a determination is made at decision block 302 that no referral source is involved, the logic proceeds from that point to block 306. At block 306 the system identifies a content source, such as a social media post, website, blog, advertisement, product review or publication or other online source of data. This may be represented in a variety of forms, such as a URI, network parameter, resource path name, GUID, alphanumeric identifier, defined search query, and the like.

At decision block 308, in the preferred embodiment, the system determines whether content topics are associated with the event, either the referral source or the content source. This step is optional, however, dependent on whether one or more content topics exist, as well as whether the particular application desires such correlation. If one or more content topics are associated with the event, the logic proceeds to block 310, where the event may be correlated with the content topics, after which the resultant correlation may be stored on a catalog or other server at block 312. At this point the logic may either proceed to block 314 or to merge/correlate data block 324.

At block 314, the system identifies a viewing user, for example an individual or organization, viewing the content source. This may occur regardless of whether there has been an identified referral source or content topic. At decision block 316, a determination is made whether the content source associated with the viewing user was shared. If not, the logic proceeds to block 318, where the view of the content source is stored indicating that the viewing user is the first user. At this point the logic proceeds to merge/correlate data block 324. If the determination is made at decision block 316 that the content source was shared, the logic proceeds to block 320, where the system identifies the sharing user. At block 322, the system stores information related to the consumption of the content source. The logic proceeds at this point to merge/correlate data block 324.

At block 324, data related to the referral source, if any, the content source, the content topics, if any, and the viewing and sharing users, if any, are merged and correlated by the system. This data is also referred to as partial graph information. At block 326, the merged data, or partial graph information, is stored in a server.

While the preferred embodiment of the invention has been illustrated and described, as noted above, many changes can be made without departing from the spirit and scope of the invention. For example, the timing of the storage function and location may be altered within the scope of the present invention. In addition, as noted above, depending on the scope of the analytics sought, identifying and merging information related to content topics and referral sources may be optional. Accordingly, the scope of the invention is not limited by the disclosure of the preferred embodiment. Instead, the invention should be determined entirely by reference to the claims that follow.

1. A method for iterative collection of information content, comprising:
identifying a content source associated with a first user;
identifying a user action of the first user related to the content source;
if association with a content topic is desired, correlating the content source with at least one content topic;
if the user was referred to the content source from a referral source,
identifying the referral source; and
if the referral source is associated with a content topic, correlating the referral source with at least one content topic associated with the referral source;
storing identification of the first user, the content source, the first user action, the identity of the referral source, if any, and the results of the correlation of the content source with content topics in a catalog server;
if the first user refers the content source to a second user,
identifying at least one second user action related to the content source;
storing identification of the second user, the content source, the second user action, the identity of the referring first user, and the results of the correlation the content source with content topics in the catalog server; and
merging the results of the correlation of the second user action related to the content source with the results of the correlation of the first user action related to the content source; and
storing the merged results in the catalog server.

2. The method of claim 1, further comprising if previous results of the correlation of prior user actions related to content sources exist, merging the results of the correlation of the first user action related to the content source with the results of the correlation of the prior user actions related to content sources.

3. The method of claim 2, further comprising if the first user refers the content source to a second user, merging the results of the correlation of the second user action related to the content source with the results of the correlation of the prior user action related to the content source.

4. The method of claim 1, wherein the content source comprises at least one of a social media post, website, blog, advertisement, product review or online publication.

5. The method of claim 1, wherein the user action comprises at least one of viewing, consuming or sharing related to the content source.

6. The method of claim 1, wherein the referral source comprises at least one of a user, a content source or a location.

7. A method for analysis of information content based on a user action related to a content source, comprising:
retrieving information about the identification of the user, the content source, the user action related to the content source, the identity of a referral source, if any, and the results of correlation the content source with content topics from a catalog server;
assigning a ranking to at least one of the identified user, the content source, the content topic and the referral source based on a predetermined criteria;
determining a polarity measure as a function of the content source; and
generating an influence measure associated with at least one of the identified user, the content source, the content topic and the referral source as a function of the ranking and polarity measures.

8. The method of claim 7, wherein the ranking associated with the identification of the user, the content source, the user action, the identity of a referral source, if any, and the results of correlation of the user action related to the content source with at least one content topic is assigned as a function of a probability distribution.

9. The method of claim 7, wherein the content source comprises at least one of a social media post, website, blog, advertisement, product review or online publication.

10. The method of claim 7, wherein the user action comprises at least one of viewing, consuming or sharing related to the content source.

11. The method of claim 7, wherein the referral source comprises at least one of a user, a content source or a location.

12. The method of claim 7, wherein polarity is determined as a function of at least one of the identified user, the user action, the content source, or the referral source.

13. A method for publication of a measure of influence of a user, a content source and at least one content topic stored in a catalog server, comprising:
receiving a query from a subscriber regarding the measure of influence of at least one of the user, the content source or the at least one content topic stored in the catalog server;
filtering an influence measure associated with the user, the content source and the at least one content topic from the catalog server as a function of the subscriber query to produce a query result;
generating a graphical output of the query result;
storing the query result and graphical output on a catalog server; and
providing the subscriber with at least one of the query result or graphic output of the query result.

14. The method of claim 13, wherein the content source comprises at least one of a social media post, website, blog, advertisement, product review or online publication.

15. The method of claim 13, wherein the user action comprises at least one of viewing, consuming or sharing related to the content source.

16. A system for iterative collection, analysis and publication of information content, comprising:
a content source;
an input device configured to receive a user action related to the content source;
a component configured to correlate the user action related to the content source with at least one content topic;
a content storage device configured to store identification of the user, the content source and the user action, and the results of correlation of the user action related to the content source with at least one content topic
a component configured to receive a subscriber query regarding the measure of influence of at least one of the user, the content source or the at least one content topic;
a component configured to analyze the subscriber inquiry by:
assigning a ranking to at least one of the identified user, the content source, the content topic and the referral source based on a predetermined criteria;
determining a polarity measure as a function of the content source; and
generating an influence measure associated with at least one of the identified user, the content source, the content topic and the referral source as a function of the ranking and polarity measure; and
a graphical generator configured to generate a graphical output in response to the subscriber query.

17. The system of claim 16, wherein the content source comprises at least one of a social media post, website, blog, advertisement, product review or online publication.

18. The system of claim 16, wherein the user action comprises at least one of viewing, consuming or sharing related to the content source.

19. A method for iterative collection of information content, comprising:
identifying an event;
if the event occurred based on involvement of a referral source, identifying the referral source;
identifying a content source associated with the event;
if association with a content topic is desired, identify at least one content topic;
identifying a viewing user of the content source;
if the content source was shared to the viewing user by a sharing user, identifying the sharing user;
storing identification of the event, the viewing and sharing users, the referral source, the content source and the content topic, if any, in a catalog server;
merging the data stored in the catalog server; and
storing the merged results in the catalog server.

20. The method of claim 19, wherein the event comprises at least one of viewing, consuming or sharing related by a user related to the content source.

21. The method of claim 19, wherein the referral source comprises at least one of a user, a content source or a location.

22. The method of claim 19, wherein the content source comprises at least one of a social media post, website, blog, advertisement, product review or online publication.

23. The method of claim 19, further comprising:
retrieving stored data about the event, the viewing and sharing users, the referral source, the content source and the content topic, if any, from the catalog server;
assigning a ranking to at least one of the identified viewing or sharing users, the referral source, the content source and the content topic, if any, based on a predetermined criteria;
determining a polarity measure as a function of the content source; and
generating an influence measure associated with at least one of the identified viewing and sharing users, the referral source, the content source or the content topic as a function of the ranking and polarity measures.

24. The method of claim 23, further comprising:
receiving a query from a subscriber regarding the measure of influence of at least one of the viewing or sharing users, the referral source, the content source or the content topic, if any, stored in the catalog server;
filtering an influence measure associated with at least one of the viewing or sharing users, the referral source, the content source and the content topic from the catalog server as a function of the subscriber query to produce a query result;
generating a graphical output of the query result;
storing the query result and graphical output on the catalog server; and
providing the subscriber with at least one of the query result or graphic output of the query result.
